(19) United States
(12) Patent Application Publication
(10) Pub. No.: US 2012/0327195 A1
(43) Pub. Date: Dec. 27, 2012

(54) Auto Focusing Method and Apparatus

(75) Inventor: Kun-Nan Cheng, Zhubei City (TW)

(73) Assignee: MSTAR SEMICONDUCTOR, INC., Hsinchu Hsien (TW)

(21) Appl. No.: 13/227,757

(22) Filed: Sep. 8, 2011

(30) Foreign Application Priority Data
Jun. 24, 2011 (TW) 100122296

(51) Int. Cl. H04N 5/232

(52) U.S. Cl. 348/47

(57) ABSTRACT

An auto focusing apparatus includes a first optical lens, a first light sensing unit for generating a first sensing signal according to a first image formed on the first light sensing unit, a second light sensing unit for generating a second sensing signal according to a second image formed on the second light sensing unit, an image processing circuit for generating a first image according to the first sensing signal and a second image according to the second sensing signal, and a focusing processor for generating a 3D depth according to the first image and the second image. The first optical lens or the second optical lens is repositioned according to the 3D depth.

This application claims the benefit of Taiwan application Serial No. 100122296, filed Jun. 24, 2011, the subject matter of which is incorporated herein by reference.

### BACKGROUND OF THE INVENTION

1. Field of the Invention

The invention relates in general to an auto focusing method and apparatus, and more particularly, to an auto focusing method and apparatus applied to a camera.

2. Description of the Related Art

Auto focusing is one of the fundamental features of modern cameras. With auto focusing, a most appropriate focal length of an optical lens set can be quickly determined to maximize a rate of successful photo capturing and to optimize image quality. Auto focusing is also capable of accurately tracking a fast moving object and thus enable even amateur photographers the ability to capture quality images. The camera itself may be a digital camera or a digital video camera.

It is well-known that a fundamental operation of auto focusing is based on automatically positioning the optical lens set by the camera system, so that an image of an object is clearly formed on a light sensing unit. FIG. 1A and FIG. 1B are schematic diagrams of an image formation process performed by adjusting optical lenses of a camera. As shown in FIG. 1a, an object 110 is observed through an optical lens 100 of a camera, and a formed image 120 of the object 110 is formed between the optical lens 100 and a light sensing unit 130. A position of the formed image 120 varies along with a position of the object 110. In a conventional camera structure, the light sensing unit 130 is fixed, and therefore the camera needs to position the optical lens to ensure the formed image 120 falls on the light sensing unit 130.

Referring to FIG. 1B, the camera moves the optical lens 100 towards the light sensing unit 130 by a distance d, such that the formed image 120 of the object exactly falls on the light sensing unit 130. In other words, auto focusing in a conventional camera is accomplished by controlling the position of the optical lens 100 via different approaches, allowing a formed image of an object to fall on a light sensing unit.

Conventional auto focusing can be divided into active and passive auto focusing. In one approach, before exposure, an infrared beam or an ultrasonic wave is transmitted by the camera to an object to be captured, and auto focusing is achieved by controlling the position of the optical lens according to a distance between the object and the camera obtained based on a reflected signal.

Furthermore, conventional auto focusing utilizes an image generated by the light sensing unit as a foundation for determining whether focusing is accurate. The camera correspondingly comprises a focusing processor, which determines a focusing condition of the optical lens according to clearness of the image received by the light sensing unit, and controls the position of the optical lens accordingly.

To control the position of the optical lens in the camera, a focusing processor compiles statistics on pixels of the image generated by the light sensing unit. In general, before the optical lens completes focusing, the formed image on the light sensing unit appears more blurry such that a brightness distribution of the pixels of the formed image is narrower (or a maximum brightness value is lower). Conversely, when the optical lens completes focusing, the formed image on the light sensing unit appears more clearly such that the brightness distribution of the pixels of the formed image is wider (or a maximum brightness value is higher).

FIG. 2A and FIG. 2B show a control method in connection with passive focusing techniques in accordance with the prior art. Referring to FIG. 2A, during a positioning process of the optical lens, a maximum brightness value in an image is I1 (i.e., the brightness distribution is narrower) when the optical lens is at a first position. Referring to FIG. 2B, the maximum brightness value in the image is I2 (i.e., the brightness distribution is wider) when the optical lens is at a second position. Since I2 is larger than I1, the camera determines that the second position is a better focal position than the first position. That is, the optical lens is repeatedly or successively (re)positioned according to the above principle to identify an optimal focal position.

In another approach, during the process of controlling the position of the optical lens by the focusing processor, the focusing processor determines whether focusing is appropriate according to a contrast of pixels around a predetermined position in an image generated by the light sensing unit. In general, before the optical lens completes focusing, the formed image on the light sensing unit appears more blurry such that a contrast of the pixels of the formed image is lower. Conversely, when the optical lens completes focusing, the formed image on the light sensing unit appears more clearly such that the contrast of the formed image is higher. More specifically, brightness differences between the pixels at edges of the image are quite large when the contrast is higher or, alternatively, quite small when the contrast is lower.

FIG. 3A and FIG. 3B show another control method of passive focusing according to the prior art. During a positioning process of the optical lens, a brightness variation near edges of a position p1 is determined to be smaller (as shown in FIG. 3A) than a brightness variation near edges of a position p2 (as shown in FIG. 3B). A preferred focusing result is provided by the example in FIG. 3B. Therefore, by monitoring the brightness variation, an optimal focal position can be obtained by a process of repeatedly positioning and re-positioning the optical lens. Both of the two focusing approaches described above share a common operational principle, namely when a contrast of an image is higher, clarity of the image is also higher, which infers that an optical lens is located at a preferred position. The two focusing approaches therefore can be applied concurrently and need not be limited to being applied alone.

In another auto focusing method of the prior art, a focal position is determined by utilizing a phase difference. FIG. 4A, FIG. 4B and FIG. 4C are schematic diagrams of an optical system that performs auto focusing by utilizing a phase difference. Referring to FIG. 4A, light signals from a same light signal source 200 through an optical lens 210 are focused on a first image formation plane 220. The first image formation plane 220 comprises an opening for allowing light near the focal point to pass through and diverge therefrom. With a set of two secondary image formation optical lenses 232 and 235 (including a first image formation optical lens 235 and a second image formation optical lens 232), the light is respectively focused at two linear image sensors 252 and 255, which respectively generate light sensing signals.

As shown in FIG. 4B, when a light signal source 200i is moved backwards to a position of another light signal source 200ii, dotted light beams become out of focus on the image plane 220, and positions where the dotted light beams transmit through the secondary image formation optical lenses set 232 and 235 are also changed. Therefore, the formed image from the first image formation optical lens 235 on the first linear image sensor 255 is moved slightly upward, and the formed image from the second image formation optical lens 232 on the second linear image sensor 252 is moved slightly downward. As a result, a distance between the light on the two linear image sensors 252 and 255 becomes larger.

Referring to FIG. 4C, a waveform 455s is generated by the first linear image sensor 255, and a waveform 452s is generated by the second linear image sensor 252. A distance between two maximum values of the two waveforms is referred to as a phase difference PD. When the optical system in FIG. 4A forms an image of an object at the image formation plane, the two waveforms 452s and 455s overlap, with the phase difference between the two being 0. When the object moves, a focal point may be adjusted according to the phase difference between the two waveforms 452s and 455s.

### SUMMARY OF THE INVENTION

The invention is directed to a novel auto focusing method and apparatus distinct from the conventional auto focusing techniques described above. The auto focusing method and apparatus provided by the present invention determines a distance between an object and a camera according to a three-dimensional (3D) depth and determines a focal position of an optical lens according to the 3D depth.

According to an aspect of the present invention, an auto focusing apparatus is provided. The auto focusing apparatus comprises: a first optical lens; a first light sensing unit, for receiving an image of an object formed through the first optical lens, and generating a first sensing signal according to the image; a second optical lens; a second light sensing unit, for receiving an image of the object formed through the second optical lens, and generating a second sensing signal according to the image; an image processing circuit, for generating a first image according to the first sensing signal and a second image according to the second sensing signal; and a focusing processor, for positioning the first optical lens or the second optical lens according to a 3D depth calculated according to the first image and the second image. The first optical lens or the second optical lens is positioned according to the 3D depth.

According to another aspect of the present invention, an auto focusing apparatus is provided. The auto focusing apparatus comprises: a camera, comprising a first camera lens set and a focusing processor, the first camera lens set outputting a first image to the focusing processor; and a second camera lens set, for outputting a second image to the focusing processor. The focusing processor calculates a 3D depth according to the first image and the second image, and controls focal distances of the first camera lens set or the second camera lens set according to the 3D depth.

According to yet another aspect of the present invention, an auto focusing method is provided. The method comprises steps of: adjusting a position of a first optical lens or a position of a second optical lens to capture an object to correspondingly generate a first image and a second image; determining whether a 3D depth can be obtained according to the first image and the second image; and obtaining a position displacement of the first optical lens or the second optical lens according to the 3D depth when the 3D depth is obtained.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIGS. 1A and 1B are schematic diagrams of an image formation process implemented by adjusting optical lenses of a camera.

FIGS. 2A and 2B are schematic diagrams of a first control method of a conventional passive auto focusing technique.

FIGS. 3A and 3B are schematic diagrams of a second control method of a conventional passive auto focusing technique.

FIGS. 4A, 4B and 4C are schematic diagrams of an optical system that performs auto focusing by utilizing a phase difference.

FIGS. 5A and 5B are schematic diagrams of images presented to the eyes when an object is perceived by the both eyes.

FIGS. 6A, 6B, 6C and 6D illustrate a method for determining a position of an object by utilizing images simultaneously perceived by both eyes.

FIG. 7 is a schematic diagram of an auto focusing apparatus according to an embodiment of the present invention.

FIGS. 8A and 8B illustrate calculations for a distance between an object and a camera based on a 3D depth according to an embodiment of the present invention.

FIG. 9 is a flowchart of an auto focusing method according to an embodiment of the present invention.

FIG. 10 is a schematic diagram of a single lens reflect (SLR) camera that forms an image with a dual lens structure.

FIG. 11 is a schematic diagram of an auto focusing apparatus according to another embodiment of the present invention.

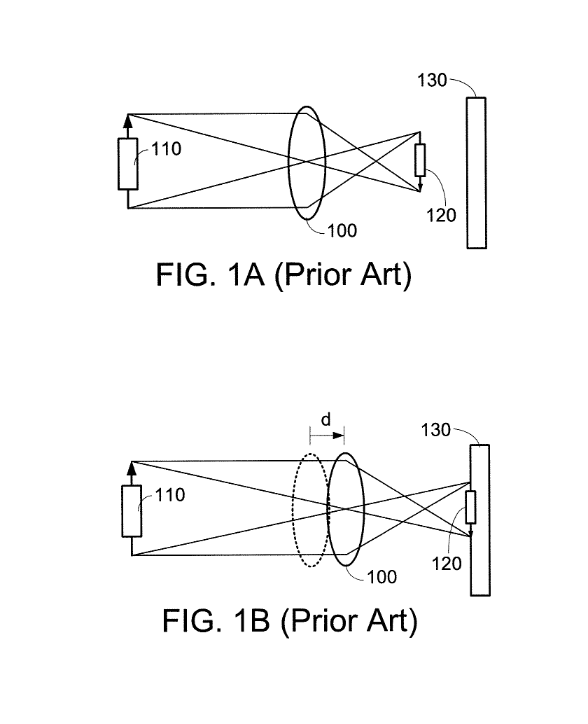

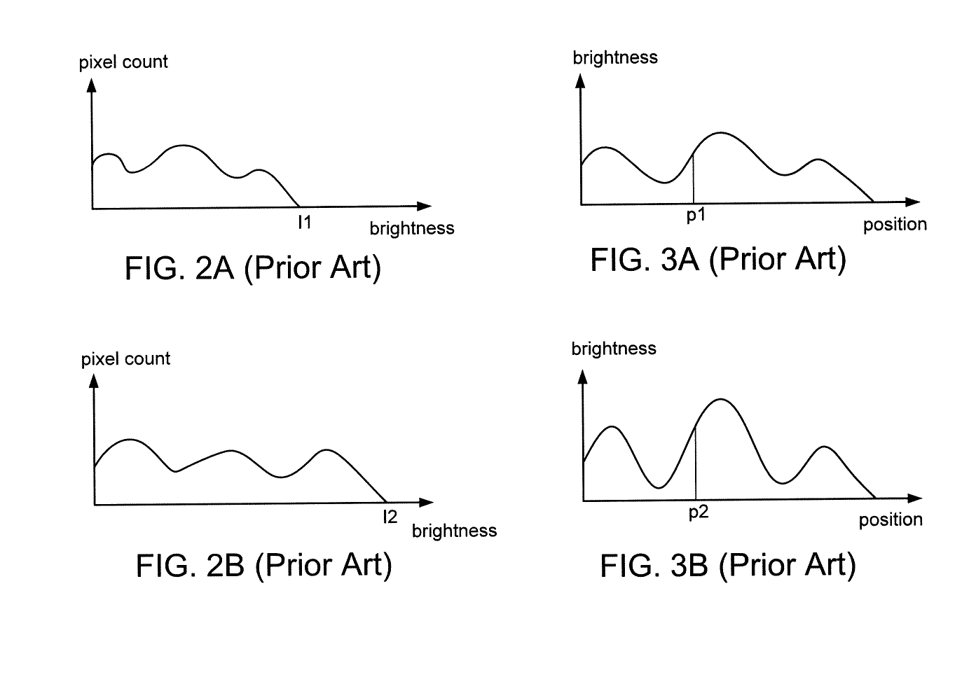

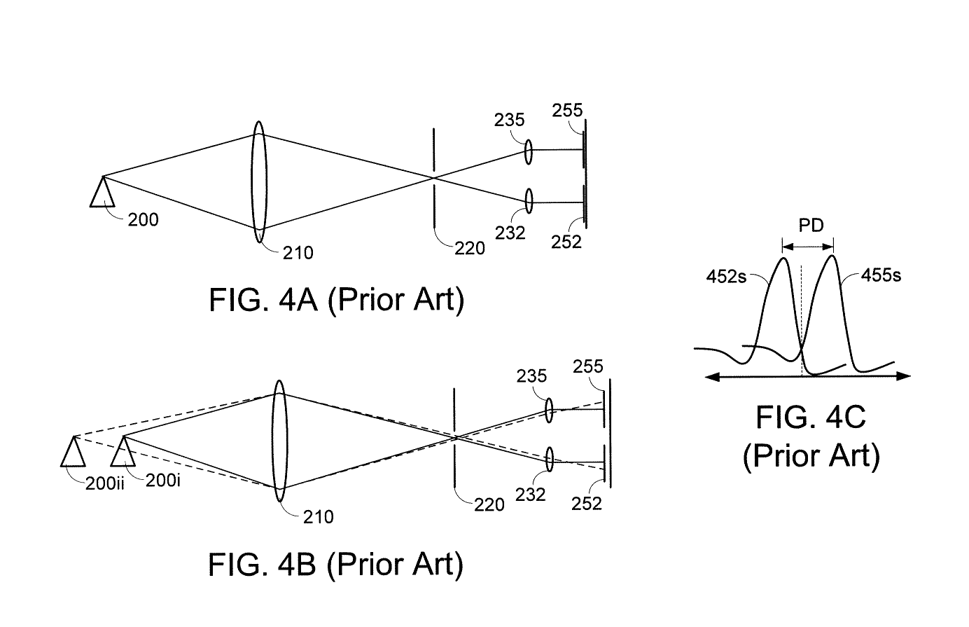

### DETAILED DESCRIPTION OF THE INVENTION

According to the present invention, two images are formed with a camera, and a 3D depth is generated according to the images. According to the 3D depth, a distance between an object and an optical lens is determined to position the optical lens and thus achieve auto focusing.

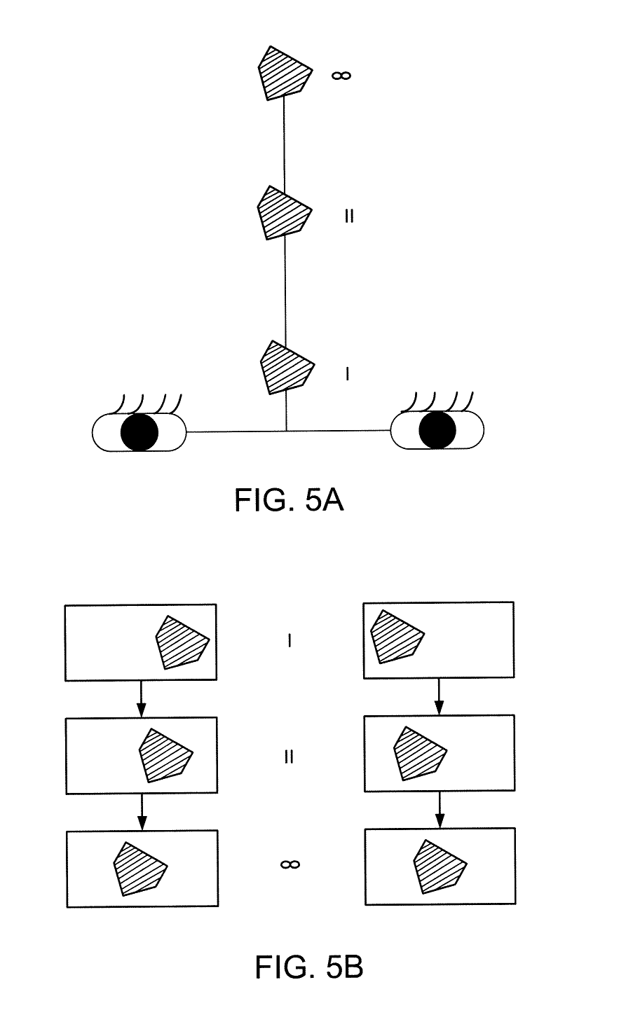

A human brain establishes a 3D visual effect according to images perceived by left and right eyes. Certain differences exist between images presented to the left and right eyes when an object is perceived by the left and right eyes, and a human brain then establishes a 3D image according to the images perceived by the both eyes. FIGS. 5A and 5A show schematic diagrams of image formation from respective eyes when an object is perceived by both eyes.

When an object is closely located at a position ‘I’ right in front of the eyes, the object perceived by the left eye is located at the right side of the left-eye visual range, and the object perceived by the right eye is located at the left side of the right-eye visual range. As the object continues to move away from the eyes, the object perceived by the left and right eyes gradually moves towards the center of the respective visual ranges. When the object is at an infinite position right in front of the eyes, the object perceived by the left eye moves to the center of the left-eye visual range, and the object perceived by the right eye moves to the center of the right-eye visual range.

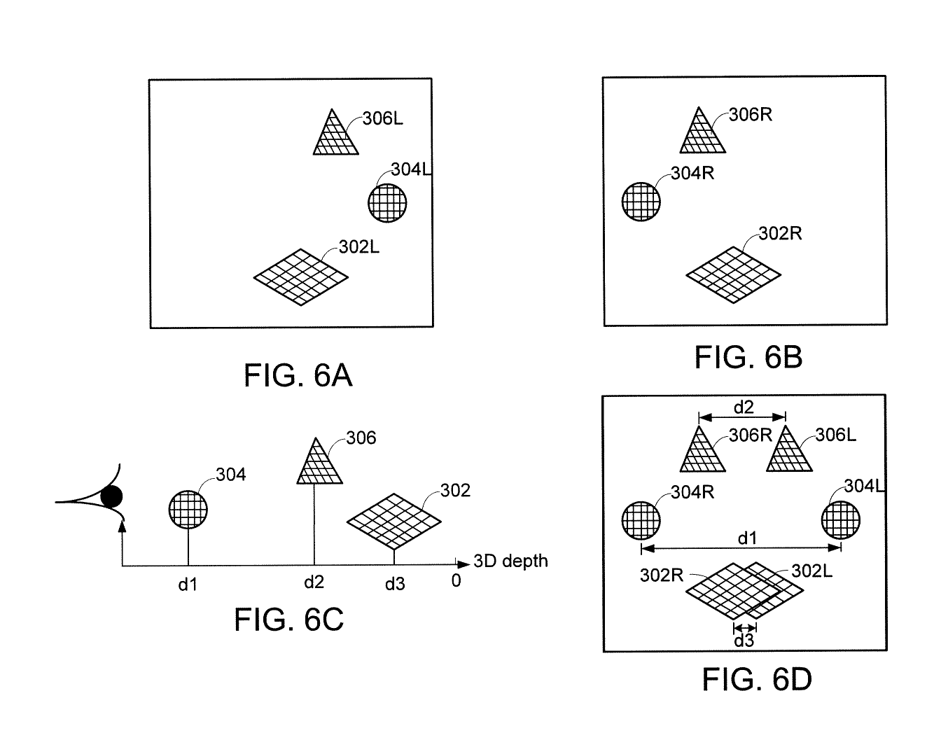

Based on the abovementioned features, a concept of 3D depth is developed. FIGS. 6A, 6B, 6C, and 6D illustrate a method for determining a position of an object by utilizing images simultaneously perceived by both eyes. Objects in images described below are all located right in front of both eyes.

Suppose three objects in a left-eye visual range image are shown in FIG. 6A, with a rhombus 302L close to the center, a circle 304L at the right, and a triangle 306L between the rhombus 302L and the circle 304L. Also suppose three objects in a right-eye visual range image are as shown in FIG. 6B, with a rhombus 302R close to the center, a circle 304R at the left, and a triangle 306R between the rhombus 302R and the circle 304R. Accordingly, distance from the three objects to the eyes are shown in FIG. 6C; that is, a circle 304 perceived by both eyes is closest to the eyes, a triangle 306 is the second closest, and a rhombus 302 is furthest from the eyes.

With reference to FIG. 6D, supposing the right-eye visual range image in FIG. 6B is defined as a reference image, a horizontal distance resulting from visual difference/visual range between same objects in the two images shown in FIGS. 6A and 6B is referred to as a 3D depth between the two images. Referring to FIG. 6D, the circle 304L is located at the right of the circle 304R by a distance d1, meaning that the 3D depth of the circle 304 is d1. Similarly, the 3D depth of the triangle 306 is d2, and the 3D depth of the rhombus 302 is d3. It can be inferred from the illustration above that, an object is located at an infinite position when its 3D depth is 0.

An image with 3D visual effects is formed based on the concept of 3D depth. The auto focusing method and apparatus of the present invention leverage the 3D depth concept described above.

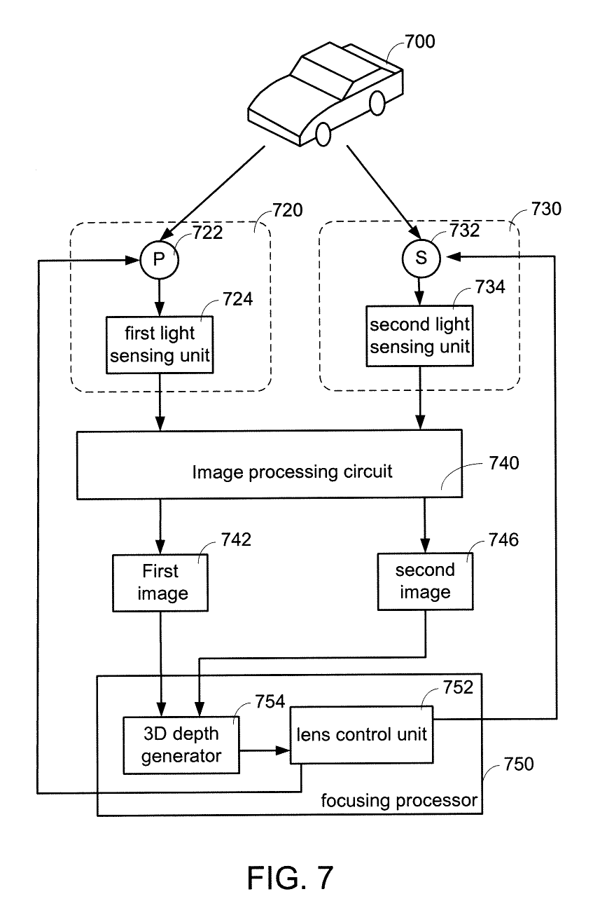

FIG. 7 shows a schematic diagram of an auto focusing apparatus according to an embodiment of the present invention. A dual camera lens 3D camera is taken as an example for the auto focusing apparatus in the following description.

The 3D camera comprises two camera lenses 720 and 730, which may be of a same specification, for example. The first camera lens (left camera lens) 720 comprises an optical lens (P) 722 and a first light sensing unit 724. The second camera lens (right camera lens) 730 comprises a second optical lens (S) 732 and a second light sensing unit 734. The first optical lens (P) 722 forms an image of an object 700 on the first light sensing unit 724 and outputs a first sensing signal. The second optical lens (S) 732 forms an image of the object 700 on the second light sensing unit 734 and outputs a second sensing signal. An image processing circuit 740 receives the first and second sensing signals and respectively generates a first image (left image) 742 and a second image (right image) 746. In general, the 3D camera generates a 3D image according to the first image 742 and the second image 746, however the approach and apparatus that generate the 3D image are omitted herein as they are irrelevant to the present invention—only description of the auto focusing apparatus are given as follows.

According to an embodiment of the present invention, a focusing processor or apparatus 750 comprises a 3D depth generator 754 and a lens control unit 752. The 3D depth generator 754 receives the first image 742 and the second image 746, and calculates the 3D depth of the object 700. The lens control unit 752 positions either the first optical lens (P) 722 or second optical lens (S) 732 or both of the first optical lens (P) 722 and second lens (S) 732 concurrently according to the 3D depth to move the first optical lens (P) 722 and second optical lens (S) 732 to optimal focal positions.

As previously described, the 3D depth of the object is the distance between left eye and right eye images of the object. Therefore, the 3D depth is associated with the distance between the first camera lens 720 and the second camera lens 730 as well as the distance between the object and the camera. More specifically, when the object is at a predetermined distance, the shorter the distance between the first camera lens 720 and the second camera lens 730 is, the smaller the 3D depth of the left and right images of the object becomes; on the contrary, the 3D depth becomes larger when the distance gets farther.

In the 3D camera, since the distance between the first camera lens 720 and the second camera lens 730 is known, a mathematical function is established to describe a relationship between the 3D depth and the distance between the object and the camera and stored in the lens control unit 752. When the 3D depth is acquired by the camera, the distance between the object and the camera can be immediately obtained according to the mathematical function. Furthermore, a look-up table (LUT) may be built in the lens control unit 752, and the distance can then be quickly identified from the LUT when the camera acquires the 3D depth. Alternatively, the LUT in the lens control unit 752 may also represent a relationship between the 3D depth and the position of the optical lens, such that the optical lens may be quickly repositioned according to the LUT when the camera acquires the 3D depth to directly complete auto focusing.

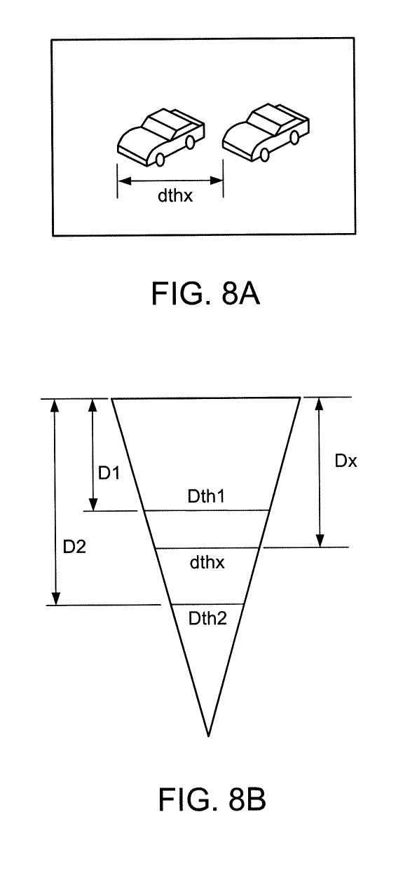

FIG. 8A and FIG. 8B illustrate calculations for the distance between the object and the camera based on the 3D depth according to an embodiment of the present invention. As shown in FIG. 8A, 3D depth generator 754 compares objects in the left and right images to determine that the 3D depth is ‘dthx’.

Referring to FIG. 8B, the distance between the object and the camera is D1 when the 3D depth is Dth1, and the distance is D2 when the 3D depth is Dth2. A mathematical function is accordingly established in the lens control unit 752. When the lens control unit 752 receives the 3D dept dthx output from the 3D depth generator 754, the distance Dx between the object and the camera is obtained and focal positions of the first camera lens and the second camera lens are then accordingly controlled to achieve auto focusing.

Basically, clear images are not necessary for obtaining the 3D depth from comparing the distances between the objects in the left image 742 and the right image 746. That is to say, images captured before complete focusing of the two camera lenses 720 and 730 may be already adequate for calculating the 3D depth of the object. According to an embodiment of the present invention, any identifiable edge of the object in the left image 742 and an identifiable same edge in the right image 7 of the object are sufficient for obtaining the 3D depth of the object.

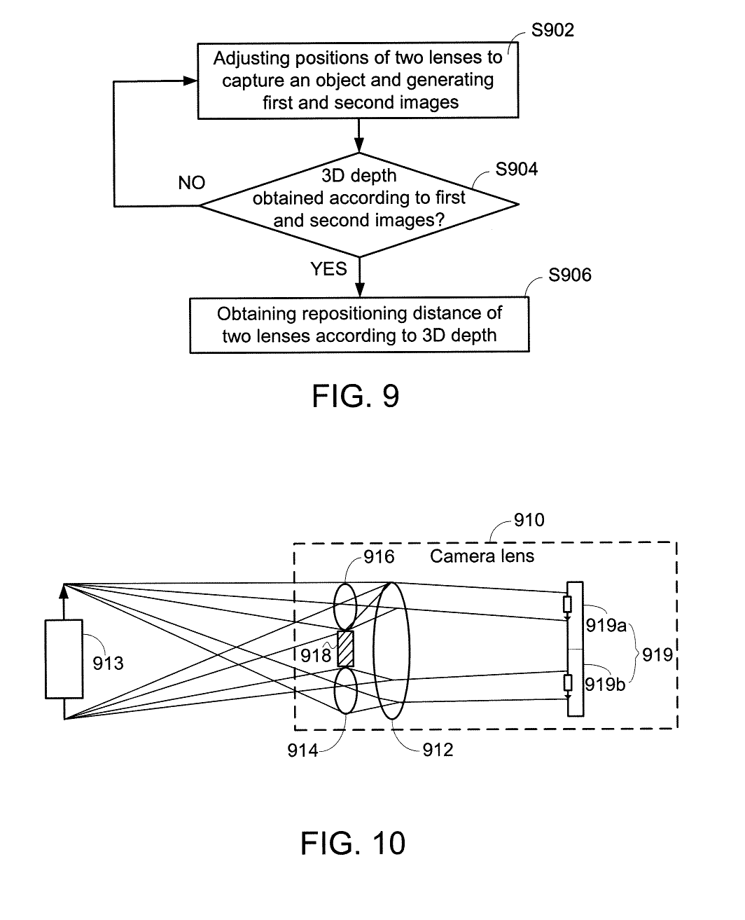

FIG. 9 shows a flowchart of an auto focusing method according to an embodiment of the present invention. In Step S902, positions of the two optical lenses are adjusted to capture an object to generate a first image and a second image. In this step, the first optical lens (P) 722 and the second optical lens (S) 732 are adjusted by the lens control unit 752, and positions of the two optical lenses do not need to be extremely accurate.

In Step S904, determining whether a 3D depth can be acquired according to the first image and the second image is performed. In this step, the 3D depth generator 754 receives the first image and the second image to calculate the 3D depth. When the 3D depth generator 754 is incapable of obtaining the 3D depth, it means that the first image and the second image are too blurry. The method then iterates Step S902 to again position the two optical lenses to capture the object to generate a new first image and a new second image. According to an embodiment of the present invention, for example, the focusing processor 750 sets the object to be located from near to far at a distance of 1 meter, 5 meters, 10 meters and an infinite distance from the camera to sequentially coarse tune the two optical lenses. In another embodiment, for example, the object is set to be located from far to near at an infinite distance, a distance of 20 meters, 10 meters and 1 meter from the camera.

In contrast, when the 3D depth is obtained, distances that the two optical lenses are to be moved (i.e., positioning displacements of the two optical lenses) are determined according to the 3D depth, and an image is respectively formed on the first light sensing unit and the second light sensing unit, as shown in Step S906. In this step, the positioning displacements of the two optical lenses are acquired according to the 3D depth and a mathematical function or an LUT by the lens control unit 752, so as to adjust positions of the first optical lens (P) 722 and the second optical lens (S) 732 and to accurately form images of the object on the first light sensing unit 724 and the second light sensing unit 734.

Therefore, the present invention utilizes a dual-lens structure to capture an object to obtain a first image and a second image, calculates a 3D depth of the object according to the first image and the second image, and adjusts positions of the two optical lenses according to the 3D depth, thereby accurately forming images of the object on a first light sensing unit and a second light sensing unit to achieve auto focusing.

In the description above, a 3D camera comprising two camera lenses is taken as an example; however, the invention is not limited thereto. FIG. 10 shows a schematic diagram of a camera, which comprises a single camera lens and forms images with two optical lenses. A camera lens 910 comprises a first optical lens 912, a second optical lens 914, a third optical lens 916, an optical shielding unit 918, and a light sensing device 919. An image of an object 913 is formed through the second optical lens 914 and the first optical lens 912 at a first section 919b of the light sensing device 919. Meanwhile, an image of the object 913 is also formed through the third optical lens 916 and the first optical lens 912 at a second section 919a of the light sensing device 919. The optical shielding unit 918 prevents an image to be formed on the first section 919b of the light sensing device 919 through the third optical lens 916, and similarly prevents an image to be formed on the second section 919a of the light sensing device 919 through the second optical lens 914.

Accordingly, the first section 919b and the second section 919a of the light sensing device 919 generate two images to be provided to a subsequent focusing processor (not shown) to generate a 3D depth, so as to achieve auto focusing by adjusting positions of the first optical lens 912, the second optical lens 914 and the third optical lens 916 according to the 3D depth.

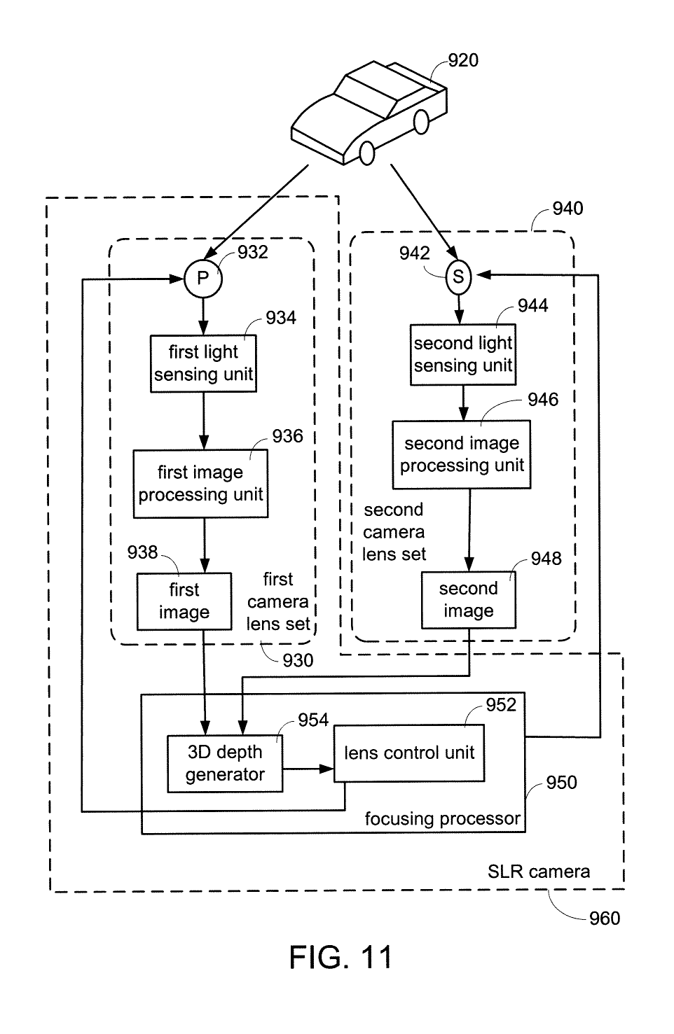

Furthermore, a single lens reflex (SLR) camera may also achieve goals of the present invention by an additional auxiliary camera lens. FIG. 11 shows a schematic diagram of an auto focusing apparatus according to another embodiment of the present invention. An SLR camera 960 comprises a first camera lens set and a focusing processor 950.

In the first camera lens set 930, a first optical lens (P) 932 forms an image of an object 920 on a first light sensing unit 934, and outputs a sensing signal to a first image processing circuit 936 to generate a first image 938.

In a second camera lens set 940, a second optical lens (S) 942 forms an image of the object 920 on a second light sensing unit 944, and outputs a second sensing signal to a second image processing circuit 946 to generate a second image 948.

A depth generator in the focusing processor 950 receives the first image 938 and the second image 948, and calculates a 3D depth of the object 920. A lens control unit 952 repositions either of the first optical lens (P) 932 and the second optical lens (S) 942 or both of the first optical lens (P) 932 and the second optical lens (S) 942 at the same time according to the 3D depth, so as to locate the first optical lens (P) 932 and the second optical lens (S) 942 to optimal focal positions.

In addition, the present invention is not limited to two camera lenses of the same specification. Referring to FIG. 11, light sensing units and image resolutions of the first camera lens 930 and the second camera lens 940 may be different. Furthermore, the second light sensing unit 944 in the second camera lens set 940 may be a monochromatic light sensing unit. With the monochromatic image 948 and the full-color first image 938, the focusing processor 950 is also capable of calculating the 3D depth of the object 920. The lens control unit 952 then repositions the first optical lens (P) 932 and the second optical lens (S) 942 according to the 3D depth, so as to locate the first optical lens (P) 932 and the second optical lens (S) 942 to optimal focal positions.

Therefore, the present invention provides an auto focusing method and apparatus, which employs a dual lens structure to capture an object to obtain a first image and a second image, calculates a 3D depth of the object according to the first image and the second image, and adjusts positions of the two optical lenses according to the 3D depth, so as to accurately form images of the object on a first light sensing unit and a second light sensing unit to achieve auto focusing.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An auto focusing apparatus, comprising:
a first optical lens;
a first light sensing unit configured to receive an image of an object formed through the first optical lens to generate a first sensing signal accordingly;
a second optical lens;
a second light sensing unit configured to receive an image of the object formed through the second optical lens to generate a second sensing signal accordingly;
an image processing circuit configured to generate a first image according to the first sensing signal and to generate a second image according to the second sensing signal; and
a focusing processor configured to position the first optical lens and the second optical lens according to a three-dimensional (3D) depth calculated according to the first image and the second image.

2. The auto focusing apparatus according to claim 1, wherein the focusing processor comprises:
a 3D depth generator configured to calculate the 3D depth of the object according to the first image and the second image; and
a lens control unit configured to calculate a distance between the object and the first optical lens according to the 3D depth, and to position the first optical lens or the second optical lens according to the distance.

3. The auto focusing apparatus according to claim 1, wherein the focusing processor comprises:
a 3D depth generator configured to receive the first image and the second image to calculate the 3D depth of the object accordingly; and
a lens control unit configured to identify a distance between the object and the first optical lens from a look-up table (LUT) according to the 3D depth, and to position at least one of the first optical lens and the second optical lens according to the distance.

4. The auto focusing apparatus according to claim 1, wherein the focusing processor comprises:
a 3D depth generator configured to receive the first image and the second image and to calculate the 3D depth of the object according to the first image and the second image; and
a lens control unit configured to identify a positioning displacement of the first optical lens or the second optical lens from a look-up table according to the 3D depth, and to position the first optical lens or the second optical lens according to the positioning displacement.

5. The auto focusing apparatus according to claim 1, wherein the first optical lens, the second optical lens, the first light sensing unit and the second light sensing unit are disposed in a single camera lens, and the first light sensing unit and the second light sensing unit are disposed in a single light sensing device.

6. The auto focusing apparatus according to claim 1, wherein the first optical lens and the first light sensing unit are disposed in a first camera lens set, and the second optical lens and the second light sensing unit are disposed in a second camera lens set.

7. An auto focusing apparatus, comprising:
a camera comprising a first camera lens set and a focusing processor, the first camera lens set configured to output a first image to the focusing processor; and
a second camera lens set configured to output a second image to the focusing processor;
wherein, the focusing processor is configured to calculate a three-dimensional (3D) depth according to the first image and the second image, and control a focal length of the first camera lens set and a focal length of the second camera lens set according to the 3D depth.

8. The auto focusing apparatus according to claim 7, wherein the first camera lens set comprises:
a first optical lens;
a first light sensing unit configured to receive an image of an object formed through the first optical lens to generate a first sensing signal accordingly; and
a first image processing unit configured to receive the first sensing signal and generating the first image.

9. The auto focusing apparatus according to claim 8, wherein the second camera lens set comprises:
a second optical lens;
a second light sensing unit configured to receive an image of an object formed through the second optical lens, and to generate a second sensing signal according to the image; and
a second image processing unit configured to receive the second sensing signal and to generate the second image.

10. The auto focusing apparatus according to claim 9, wherein the focusing processor further comprises:
a 3D depth generator configured to receive the first image and the second image and to calculate the 3D depth of the object according to the first image and the second image; and
a lens control unit configured to calculate a distance between the object and the first optical lens according to the 3D depth to position the first optical lens or the second optical lens according to the distance.

11. The auto focusing apparatus according to claim 9, wherein the focusing processor further comprises:
a 3D depth generator configured to receive the first image and the second image and to calculate the 3D depth of the object according to the first image and the second image; and
a lens control unit configured to identify a distance between the object and the first optical lens from a look-up table according to the 3D depth, and to position the first optical lens or the second optical lens according to the distance.

12. The auto focusing apparatus according to claim 9, wherein the focusing processor further comprises:
a 3D depth generator configured to calculate the 3D depth of the object according to the first image and the second image; and
a lens control unit configured to identify a positioning displacement of the first optical lens and the second optical lens from an LUT according to the 3D depth, and to position the first optical lens or the second optical lens according to the positioning displacement.

13. An auto focusing method, comprising:
capturing a first image and a second image for an object by adjusting a position of a first optical lens and a second optical lens respectively;
determining whether a 3D depth of the object can be obtained according to the first image and the second image; and
obtaining a positioning displacement of the first optical lens or the second optical lens according to the 3D depth.

14. The auto focusing method according to claim 13, further comprising:
iterating the capturing step and the determining step when the 3D depth is not obtained.

15. The auto focusing method according to claim 13, wherein the capturing step comprises sequentially adjusting the first optical lens and the second optical lens to a plurality of predetermined positions from near to far.

16. The auto focusing method according to claim 13, wherein the capturing step comprises sequentially adjusting the first optical lens or the second optical lens to a plurality of predetermined positions from far to near.

17. The auto focusing method according to claim 13, wherein when the 3D depth is obtained, the method comprises calculating a distance between the object and the first optical lens to position the first optical lens or the second optical lens accordingly.

18. The auto focusing method according to claim 13, wherein when the 3D depth is obtained, the method comprises identifying a distance between the object and the first optical lens from a look-up table (LUT) to position the first optical lens or the second optical lens accordingly.

19. The auto focusing method according to claim 13, wherein when the 3D depth is obtained, the method comprises identifying a positioning displacement of the first optical lens or the second optical lens from a look-up table to position the first optical lens or the second optical lens accordingly.

20. The auto focusing method according to claim 13, wherein the determining step comprises determining whether an edge of the first image and an edge of the second image can be identified.
